(19) United States
(12) Patent Application Publication
(10) Pub. No.: US 2026/0235934 A1
(43) Pub. Date: Aug. 13, 2026

(54) Kamera

(71) Applicant: Proton Camera Innovations GbmH, Garbsen (DE)

(72) Inventor: Marko Höpken, Garbsen (DE)

(21) Appl. No.: 19/243,588

(22) Filed: Jun. 19, 2025

(30) Foreign Application Priority Data
Jun. 21, 2024 (DE) 10 2024 117 602.4
Sep. 10, 2024 (DE) 10 2024 125 976.0

(51) Int. Cl. G03B 17/08; G02B 7/02; G03B 17/14; H04N 23/51; H04N 23/55

(52) U.S. Cl. CPC G03B 17/08; G02B 7/025; G03B 17/14; H04N 23/51; H04N 23/55

(57) ABSTRACT

The invention relates to a camera (1) which has a camera housing (4) and a lens (2) which can be screwed to the camera housing (4). The lens (2) comprises a cylindrical lens housing (6), with a lens mount (7) for screwing to the camera housing (4), and a front lens element (9) in the lens housing (6).

The lens mount (7) has an encircling flange face (8) next to the camera housing (4) and an annular seal (3) located on the lens mount (7) between the camera housing (4) and the flange face (8), the annular seal (3) being elastically deformable in a settable focus region of the camera (1) and being compressed in the focus region when the lens (2) is screwed to the camera (1). The front lens (9) has a plane surface facing toward the lens mount (7) and is leaktightly connected to the lens housing (6).

The invention relates to a camera which has a camera housing and a lens which can be screwed to the camera housing, the lens comprising a cylindrical lens housing, with a lens mount for screwing to the camera housing, and a front lens element in the lens housing.

Cameras are often used in environmental conditions that require the lens to be mounted onto the camera housing watertightly, or at least in a manner protected against spray water. For this purpose, the lens may be surrounded by a protective housing covered by a front glass. To replace the lens, the protective housing with the front glass must be disassembled or at least adjusted. In addition, the protective housing increases the weight and the size of the camera: the front glass restricts the viewing angle of the camera and can lead to shadowing and reflections in the picture taken. When the temperature changes, the front glass can disadvantageously steam up.

For watertight mounting, cameras having lenses that have been adhesively bonded in the camera housing are also known. Although this leads to very small designs, it has the disadvantage that the lens cannot be exchanged. Moreover, the focus cannot be adjusted.

Such a solution is disclosed for example in DE 10 2015 010 443A1, which comprises a modular vehicle camera system with a camera, an optical unit designed for a specific mounting position in the vehicle, and means for fastening an optically effective modular element in the path of all the incident light upstream of the optical unit in the region of the camera or the camera housing. The modular optical element may be adhesively bonded to the camera housing. This adhesive bonding of the lens element cylinder to the camera housing may take place, in particular during the production of the camera, such that the lens element is exactly aligned and then the adhesive bonding takes place.

DE 21 2021 000 493 U1 discloses a lens unit comprising a lens element, a lens tube containing the lens element, a housing groove formed in the lens tube and containing an adhesive for connecting the lens and the lens tube, and a ventilation hole for discharging air, the ventilation hole being formed in the housing groove.

This is intended to prevent the formation of cavities on an adhesive interface and in an adhesive layer.

DE 10 2021 210 306 A1 describes a camera in which a seal has been inserted into an annular gap between the lens and the housing, with the result that the housing is outwardly sealed.

DE 10 2010 012 314 A1 proposes establishing an adhesive bond between an optical module and a carrier housing in which the optical module is mounted, a defined adhesive gap and a determined alignment already being provided via the shaping of the optical module and of the carrier housing.

DE 10 2010 047 106 A1 discloses an optical device comprising a lens and a carrier housing, the lens being mounted in the carrier housing and being connected to the carrier housing via an adhesive bond. Located between the lens and the carrier housing is an additional adjustment element which allows a sealing action, an articulation action and prefixing.

In the case of the proposed imager module, the adhesive bond usually provided between the lens and the lens holder or the holding element is replaced by a welded connection. By contrast to an adhesive bond, the intended effect of the welded connection is a stable focal position even under the action of moisture and/or temperature. Before the welding, the lens can be aligned in relation to the image sensor and then fixed in place by depositing the weld seam. Weld seams are deposited only at certain points so that as little heat as possible is input during the welding.

Taking this as a starting point, an object of the invention is to provide an improved camera which can be designed compactly and with sealing against environmental influences without disadvantageously influencing the optical path, and of which the focus can be reliably and easily set during assembly and for the purpose of subsequent adjustment and also remains fixedly set during operation.

The object is achieved by the camera having the features of Claim 1. Advantageous embodiments are described in the dependent claims.

It is proposed that the lens mount has an encircling flange face next to the camera housing and an annular seal located on the lens mount between the camera housing and the flange face, the annular seal being elastically deformable in a settable focus region of the camera and being compressed in the focus region when the lens is screwed to the camera, and that the front lens has a plane surface facing toward the lens mount and is leaktightly connected to the lens housing. The annular seal may have a rectangular, round or oval cross section. The rectangular shape has the advantage of a larger plane sealing face on either side. By contrast, although the round shape in the form of an O ring has a smaller sealing face, it can be elastically deformed with a greater variation in the thickness given the same material and thus provides more reliable sealing than a rectangular cross section does. An oval cross section affords a compromise between the advantages and disadvantages of rectangular and round cross sections.

The annular seal may be a rubber seal. Rubber seals have a very low modulus of elasticity in the range of 0.01 to 0.1 GPa=10*10⁶ to 100*10⁶N/m². However, silicone seals or other suitable elastic materials providing a watertight sealing effect are also conceivable. They can thus be compressed to a large proportion of the thickness of the annular seal and are suitable as a flange seal, which allows a variable spacing between the flange face of the lens housing and the corresponding flange face of the camera housing in order to set the focus of the lens.

The encircling peripheral region of the front lens can advantageously be adhesively bonded watertightly to the lens housing. For this, the peripheral region of the plane light passage face and/or the radially outer end edge region of the front lens can be used.

The lens mount of the lens housing may have a cylindrical screw connection, which has an external thread, and a flange adjoining the screw connection, the external thread having a first diameter and the flange having a second, outside diameter larger than the first diameter. The lens housing can thus be screwed into a lens receiving opening, the lens receiving opening being in the form of a circular recess which is in the front of the camera housing and is provided with an internal thread. The lens receiving opening may be surrounded by a plane encircling flange face serving as a support sealing face for the annular seal.

However, screwing the lens to the camera by means of a bayonet connection is also conceivable. For this purpose, the lens mount of the lens housing may have a flange with a bayonet connection for screwing the lens to the camera via a bayonet closure, the annular seal being located radially on the inside of the bayonet connection or radially on the outside of the bayonet connection on the lens mount.

The lens housing may have an annularly encircling plane support face for supporting the plane surface of the front lens. As an alternative or in addition to this, the lens housing may have a circumferential side wall, i.e. a collar, enclosing the front lens around the outer circumference. This makes it possible to adhesively bond the front lens to the plane support face and/or between the end face of the front lens and the inner wall face of the circumferential side wall around the circumference and watertightly. The circumferential side wall makes it possible to form-fittingly guide the front lens into its final position during assembly. The circumferential side wall form-fittingly holds the front lens during operation and protects it against external mechanical action.

The encircling flange face may be formed by an adapter ring located on the lens housing. This makes it possible to provide a thickness compensation if a larger spacing is required between the camera housing and the bearing surface on the objective housing to set the focus and this spacing can no longer be achieved owing to the elasticity of the annular seal. The adapter ring may be in the form of a further annular seal or preferably a rigid, non-elastic compensating disk which provides the flange face for the annular seal to bear against and is supported on the lens housing.

The adapter ring may be watertightly connected, for example adhesively bonded or welded, to the lens housing. In this way, for a lens housing which itself does not have a suitable or sufficiently plane flange face, a sealing face for the annular seal to directly bear against can be provided.

The annular seal may be force-lockingly and/or form-fittingly connected to the lens housing. This ensures that, when the lens is exchanged, the annular seal matching the lens stays on the lens or a lens with a matching annular seal for a set composed of a camera and various lenses is provided.

In the case of an electronics device, preferably in the case of the above-described camera, having a device housing which has a housing lower part and a housing upper part and an electronics printed circuit board in the housing lower part, wherein: the housing upper part is able to be placed onto the housing lower part and connected to the housing lower part, the housing lower part having a cable-entry duct which leads toward the electronics printed circuit board and has a connection cable; and the connection cable is inserted in the cable-entry duct and electrically conductively connected to the electronics printed circuit board, a sleeve may be crimped onto the circumference of the stripped end region of the cable. When the housing upper part and the housing lower part are in the connected state, an emerging portion of the cable-entry duct emerges toward an inner wall of the housing upper part that faces toward the housing lower part, and a clamping intermediate space adjoins the emerging portion and has the sleeve clamped in it by mutually facing clamping faces of the housing upper part and the housing lower part.

In this way, a cable can be inserted into the electronics housing such that it is protected against strain and bears as leaktightly as possible against the cable-entry duct, in particular in the case of very small housings and manual assembly, the effect of this being that there are as few as possible individual parts that need to be produced and assembled.

The connection cable is not simply fixedly clamped to the insulating-material casing in order to provide strain relief. Rather, the cable is fastened by clamping a sleeve crimped onto the connection cable and is thus fastened around the circumference of the cable. The clamping is effected via the mutually facing clamping faces of the housing lower part and housing upper part by placing the housing upper part onto the housing lower part and connecting it to the housing lower part, for example by screws or latching elements.

When a metal sleeve is used, at the same time it is also possible to fasten the metal sleeve to the electronics circuit board, it also being possible as a result to electrically connect the cable via the metal sleeve. The metal sleeve can thus be soldered to the electronics printed circuit board or connected thereto by a clamping-contact connection, such as a spring-force clamping contact or screw clamping contact. The metal sleeve may optionally be soldered to the outer conductor. This makes it possible to obtain improved contact and mechanical retention in particular in the case of thin strands of the outer conductor.

The cable-entry duct may extend from an outer side of the housing lower part to the inner wall of the housing upper part that faces toward the housing lower part. In this case, the emerging portion can preferably form the entire length of the cable-entry duct. This makes it possible to insert the cable quickly and easily for the final assembly of the electronic device.

In another variant, it is conceivable that the cable-entry duct has at least one bend starting from the outer side and at its end region runs out by way of the emerging portion, which emerges toward the clamping face of the housing upper part. This allows the connection cable to be received with even more strain resistance in the housing lower part by virtue of the at least one further bend.

The cable-entry duct may be a bore. This drilled hole is preferably a fitting bore for the cable, which can thus be received in the housing lower part in an interference fit in strain-resistant fashion and tightly with respect to environmental influences. This makes it possible to obtain an at least dust-tight installation of the cable and preferably a moisture-tight or even watertight installation of the cable.

The clamping face of the housing lower part may span a plane aligned transversely to the direction of longitudinal extent of the emerging portion. This forces a bend in the cable inserted in the cable-entry channel and therefore causes the connection cable to be fastened to the device housing in strain-resistant fashion.

The cable-entry duct and the clamping face of the housing lower part can adjoin a side wall of the housing lower part. The side wall thus forms, together with the clamping face, a guiding and retaining face for the cable for form-fittingly fixing the latter in place on the device housing in strain-resistant fashion.

The electronics printed circuit board may have a soldering face adjacent to the clamping face of the device lower part. The metal sleeve may have been soldered onto the soldering face, or be soldered onto the soldering face together with the preferably already crimped-on metal sleeve during final assembly and after the cable has been inserted. In this way, the connection cable and the metal sleeve crimped onto it are electrically conductively connected to the electronics printed circuit board adjacently to the clamping face. This shortens the line paths and reduces the space requirement needed for receiving the cable.

The connection cable can have an outer conductor electrically conductively crimped to the metal sleeve and an inner conductor, the electronics printed circuit board having a connection element for electrically conductively connecting an inner conductor.

The connection element may be a solder connection or a plug-in contact connection.

The connection cable may have multiple inner conductors each connected to a connection element of the electronics printed circuit board.

The connection cable may be a coaxial cable with a shielding mesh as outer conductor and a coaxial inner conductor.

The electronics device may be a camera which has an image sensor connected to the electronics printed circuit board and a lens mount on the housing upper part.

The method for assembling the above-described electronics device has the following steps:
a) inserting the cable into the cable-entry duct;
b) connecting the cable to the electronics printed circuit board, which involves soldering the metal sleeve, which has been crimped onto the end region of the connection cable, onto a soldering face of the electronics printed circuit board;
c) placing the housing upper part onto the housing lower part, in which the electronics printed circuit board has been installed and the connection cable connected thereto has been inserted; and
d) closing the housing by pressing in the metal sleeve lying between the mutually oppositely situated clamping faces of the housing.

This makes it possible to achieve easy and quick assembly of very compact electronics devices with few individual parts, in order to achieve strain-resistant installation of a cable guided out of the device housing. The configuration of the device housing and of the cable allows a shortening of the assembly time together with a very small required structural space.

The sleeve establishes a force fit with the connection cable by crimping and, if appropriate assisted by optional soldering, with the outer conductor and/or optional additional soldering on the electronics printed circuit board.

If the sleeve has smaller dimensions than the diameter of the cable-entry duct, the connection cable can be plugged through the cable-entry duct with a sleeve already crimped on in advance. This is appropriate primarily for small bores in miniature cameras.

The use of a metal sleeve crimped on an outer conductor of the cable and additionally pressed in by way of the contact faces in the device housing makes it possible, when combined with soldering of the metal sleeve on the electronics printed circuit board, to achieve good contact of the shield. Moreover, the position of the cable is fixed by the soldering on the electronics printed circuit board, and this leads to simplified further handling during assembly.

The invention will be explained in more detail below on the basis of exemplary embodiments using the appended drawings, in which:

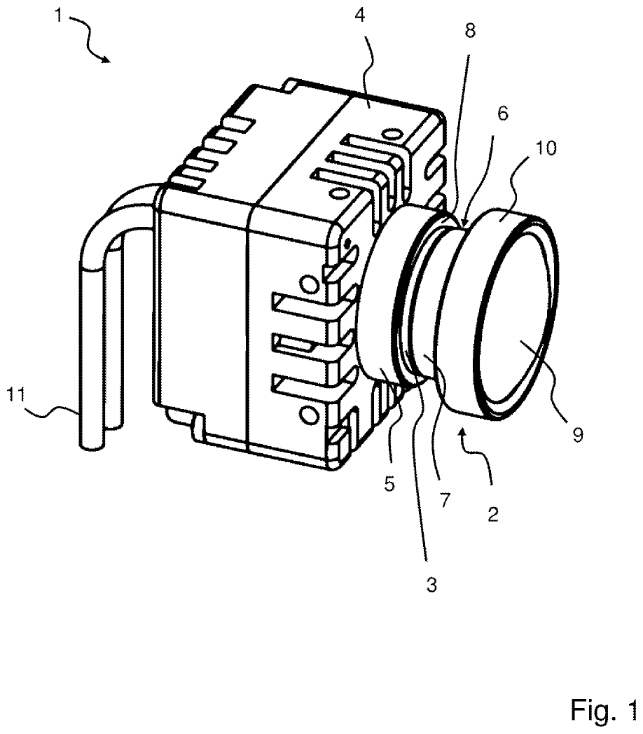

FIG. 1—shows a perspective view of a camera with a lens and an annular seal;

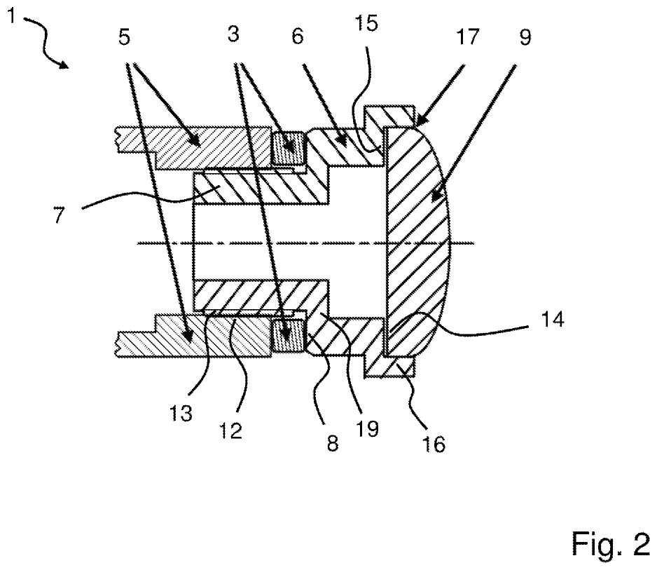

FIG. 2—shows a cross-sectional view through the lens receptacle of the camera and the lens leaktightly screwed thereto;

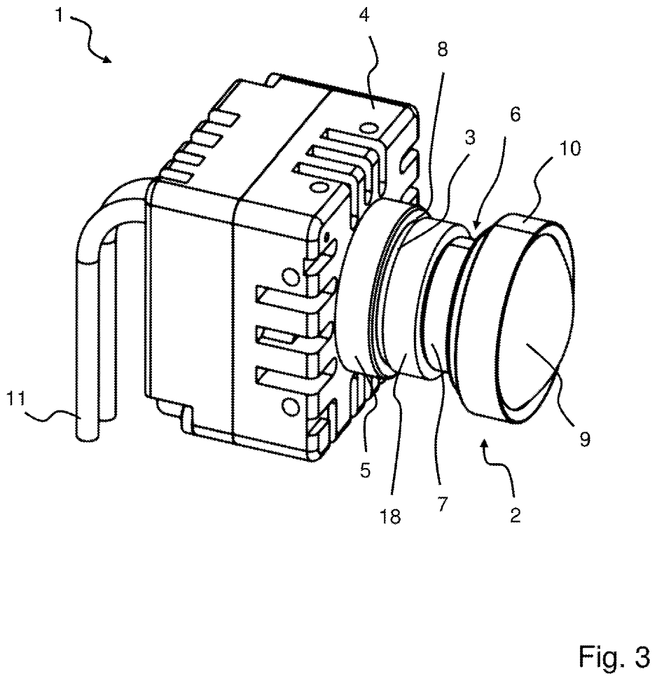

FIG. 3—shows a perspective view of a camera with a lens and an additional adapter ring as a flange face;

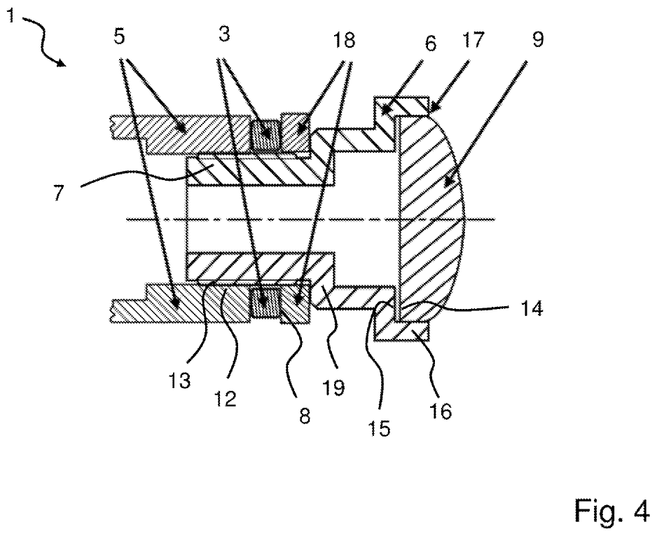

FIG. 4—shows a cross-sectional view through the lens receptacle of the camera and the lens leaktightly screwed thereto;

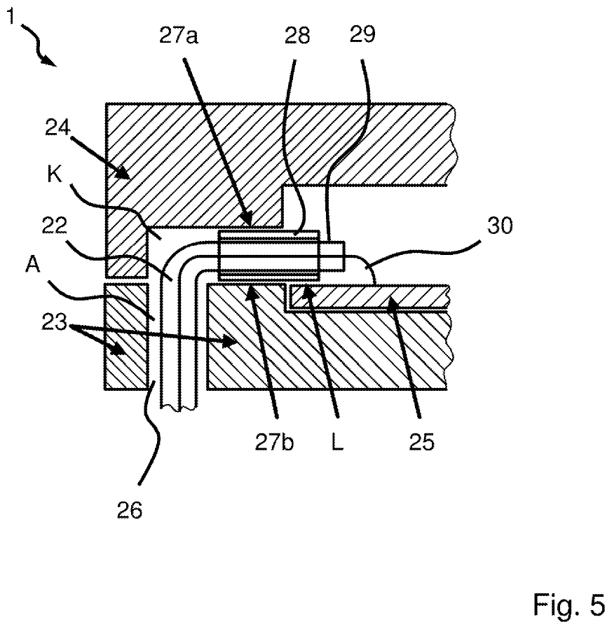

FIG. 5—shows a detail of a camera housing in a sectional side view, with a cable installed;

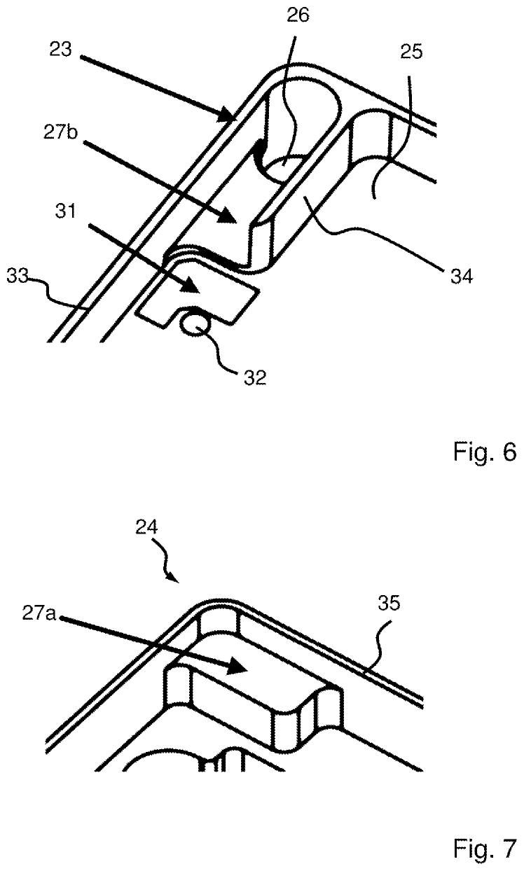

FIG. 6—shows a detail view of the inner side of a housing lower part;

FIG. 7—shows a detail view of the inner side of a housing upper part;

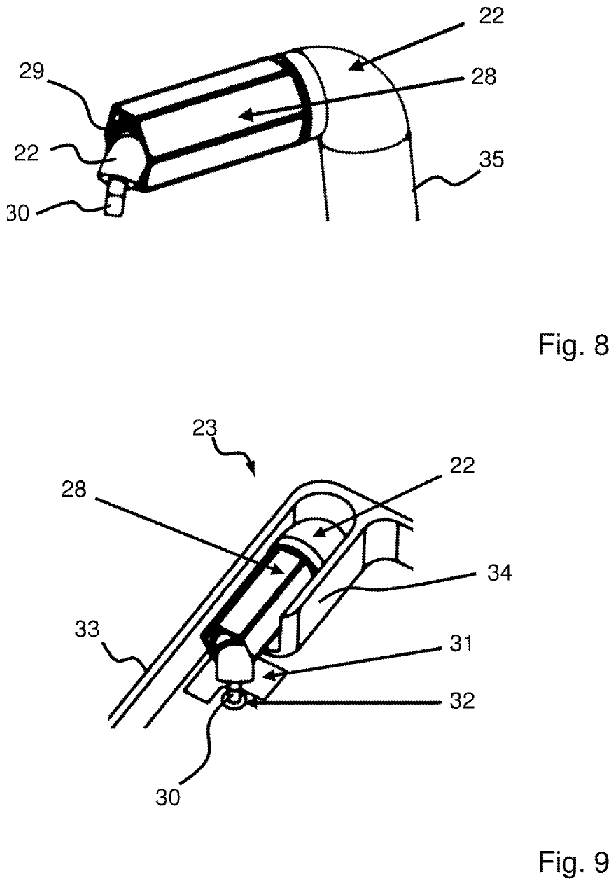

FIG. 8—shows a perspective view of a cable with a crimped-on metal sleeve;

FIG. 9—shows a detail view of the inner side of a housing lower part from FIG. 2 with a cable installed.

FIG. 1 shows a perspective view of a camera 1 which has a lens 2 and an annular seal 3 between the camera 1 and the lens 2.

The camera 1 has a camera housing 4, which can have for example a two-part design with a main housing part and a front housing part (cover part) and has, on its front face, a lens receiving opening 5 with an internal thread. The lens 2 has a lens housing 6 with a cylindrical lens mount 7, which is surrounded by the annular seal 3 around the circumference and is screwed into the internal thread of the lens receiving opening 5 by way of an external thread. The lens mount 7 can also be referred to as a lens receptacle.

The lens receiving opening 5 is in the form of a circular recess which is provided with an internal thread and is in the front of the camera housing 4. The lens receiving opening 5 is surrounded by a plane encircling flange face 8 serving as a support sealing face for the annular seal 3.

Installed in the front side of the lens housing 6 is a front lens 9, which is surrounded by a laterally encircling circumferential side wall 10, i.e. a collar wall. The front lens 9 is watertightly connected to the lens housing. To this end, of the front lens 9 may be encirclingly adhesively bonded around the circumference to a correspondingly plane support face of the lens housing 6 by way of a plane support face and/or to the inner side of the circumferential side wall 10 by way of a circumferential end face.

An electric line 11 can be guided out of the housing 4, this electric line being able to be used to supply electrical energy and/or as a data line for transmitting the digital image data and possibly control data. This electric line 11 may be guided watertightly out of the camera housing 4, for example with a rubber seal. Other solutions are similarly conceivable.

FIG. 2 shows a cross-sectional view through the lens receiving opening 5 of the camera 1 and the lens 2 leaktightly screwed thereto.

It shows that the lens housing has a lens mount 7 with a first diameter smaller than the second, outside diameter n-that of the flange 19 projecting from the cylindrical lens mount 7. The flange 19 provides, on its side facing toward the run-out end of the lens mount 7, a flange face 8 against which the annular seal 3 bears.

The annular seal 3 is clamped between an end wall of the camera housing 4 that adjoins the lens receiving opening 5 and the flange face 8 when the lens housing 6 has been screwed far enough into the camera housing 4 for the required focus to be set. The elastically deformable annular seal 3 is compressed in the settable focus region and thus watertightly seals the lens receiving opening 5.

The lens receiving opening 5 is cylindrical and has an internal thread 12 on its inner circumferential wall. The similarly cylindrical lens mount 7 has a matching external thread 13 on its outer circumferential wall. This makes it possible to screw the lens mount 7 in the lens receiving opening 5. The screw connection us watertightly sealed by means of the annular seal 3. Moreover, the lens 2 is mechanically fixedly held in place by the elastic bias of the annular seal 3. This securely prevents the lens 2 from working loose owing to vibrations.

The front lens 9 has a plane inner side which rests on a similarly plane support face 15 by way of a plane encircling peripheral region 14. This plane support can be adhesively bonded, in order to watertightly and mechanically fixedly fasten the front lens 9 to the lens housing 6. The front lens 9 is surrounded and thus mechanically protected by an encircling collar wall 16 and, on assembly, is guided into the desired optically centered position.

The front lens 9 may be watertightly and mechanically fixedly connected to the lens housing 6 by an adhesive bond 17 between the encircling, radially outer end wall of the front lens and the collar wall 16.

FIG. 3 shows a perspective view of a camera 1 which has a screwed-in lens 2 and an additional adapter ring 18 as flange face 8.

This adapter ring 18 located between the lens mount 7 and the annular seal 3 makes it possible to increase the spacing between an image sensor installed in the interior space of the camera housing 4 and the front lens 9. This can be advantageous for expanding the settable focus region. The adapter ring 18 provides, on its end face next to the camera housing 4 in the screwed-in state, a flange face 8.

FIG. 4 shows a cross-sectional view through the lens mount 7 of the camera 1 and the lens 2 leaktightly screwed thereto.

By comparison with FIG. 2, it shows that the annular seal 3 does not bear against the flange 19, which projects in one piece from the lens mount 7. The outside diameter of this flange 19 is smaller than the outside diameter of the annular seal 3 and thus not optimally suitable for directly supporting the annular seal 3. The adapter ring, by contrast, has a larger outside diameter than the flange 19 and thus provides an enlarged flange face 8. The annular seal 3, in turn, bears against the end wall, which runs circularly around the circumference and bounds the lens receiving opening 5, of the camera housing 4. On the diametrically opposite side of the annular seal 3, the latter bears against the flange face 8 of the adapter ring 18. The adapter ring 18 is supported on a projection of the lens housing 6, it being possible for this projection to be formed for example as illustrated by a flange 19, i.e. a protrusion for enlarging the outside diameter.

The front lens 9 has a plane inner side which rests on a similarly plane support face 15 by way of a plane encircling peripheral region 14. This plane support can be adhesively bonded, in order to watertightly and mechanically fixedly fasten the front lens 9 to the lens housing 6. The front lens 9 is surrounded and thus mechanically protected by an encircling collar wall 16 and, on assembly, is guided into the desired optically centered position.

The front lens 9 may be watertightly and mechanically fixedly connected to the lens housing 6 by an adhesive bond 17 between the encircling, radially outer end wall of the front lens and the collar wall 16.

FIG. 5 shows a sectional side view of a detail of an electronic device, by way of example in the form of a camera 1, with a connection cable 22 installed.

The camera 1 has a device housing formed from a housing lower part 23 and a housing upper part 24 placed thereon and form-fittingly and/or force-lockingly connected thereto. In the housing lower part 23, an electronics printed circuit board 25 is installed. This electronics printed circuit board 25 can be form-fittingly placed in a recess in the interior space of the housing lower part 23 and fastened to the housing lower part 23 by fastening elements, for example screws and/or latching elements.

The housing lower part 23 has a cable-entry duct 26 which emerges by way of an emerging portion toward an inner wall of the placed-on housing upper part 24 that faces toward the housing lower part 23. This inner wall of the housing upper part 24 forms a clamping face 27a. There is a clamping intermediate space K between the inner wall of the placed-on housing upper part 24, i.e. its clamping face 27a, and a clamping face 27b of the housing lower part 23 that faces toward this clamping face 27a of the housing upper part 24.

These clamping faces 27a, 27b each span a plane aligned transversely to the direction of longitudinal extent of the cable-entry duct 26.

A step of the clamping faces 27a, 27b can transition into a receiving space containing the electronics printed circuit board 25, i.e. the electronics components borne by the electronics printed circuit board 25.

It can be seen that the electric connection cable 22 has been inserted into the emerging region A of the cable-entry duct 26 and bent at an angle in the clamping intermediate space K. The angle is preferably about 90°. A sleeve 28 made of metal, which incorporates corresponding electrically conductive alloys and carbon fibers, has been crimped onto the end region of the cable 22 positioned between the clamping faces 27a, 27b and on the peripheral region of the electronics printed circuit board 25. The sleeve 28 may bear against a shielding braid of the cable 22 and optionally, in addition to the crimped force fit, be soldered to the outer conductor 29. The shielding braid forms an outer conductor 9 of the cable 22 for a ground connection. The sleeve 28 is soldered on a solder pad of the electronics printed circuit board 25 by a solder connection L.

In the interior, the connection cable 22 has at least one inner conductor 30 each of which is sheathed with an insulating-material casing and electrically conductively connected to the electronics printed circuit board 25. The connection cable 22 may for example, as illustrated, be a coaxial cable with a coaxial inner conductor 30.

The metal sleeve 28 may for example be a tube closed around the circumference or a longitudinally slotted tube. The cross section may be circular or polygonal. It is advantageous if the sleeves 28 have two mutually plane-parallel and spaced-apart wall portions situated opposite one another and bearing against the clamping faces 27a, 27b. These two wall portions may each be connected to a curved or bent wall portion on either side. The metal sleeve 28 may have for example a hexagonal cross section.

FIG. 6 Shows a Detail View of the Inner Side of a Housing Lower Part 23.

It shows that the electronics printed circuit board 25 installed therein has a soldering face 31 (solder pad) which adjoins the clamping face 27b and onto which the sleeve 28 is soldered. Adjoining the soldering face 31 is a solder connection 32 which is spaced apart from the soldering face 31 by an electrically insulating gap. The solder connection 32 may for example be a bore with a solder connection face, surrounding the bore, on the lower side (not illustrated) of the electronics printed circuit board 25 and/or on the upper side (shown in FIG. 6) of the electronics printed circuit board 25. However, it is also conceivable if, instead of the solder connection 32, there is a plug-in contact connection, such as a contact pin which has been soldered into the electronics printed circuit board 25 and onto which a contact bushing is plugged.

The contact face 27b and the cable-entry duct 26 adjoin a side wall 33 of the housing lower part 23. The side wall 33 forms, in the region of the clamping face 27b, a lateral boundary wall for guiding the inserted cable 22 and retaining it in strain-resistant fashion. Correspondingly, an inner side wall 34 adjoins the clamping face 27b. The inner side wall 34 is located between the electronics printed circuit board 25 and the clamping face 27b.

FIG. 7 shows a detail view of the inner side of a housing upper part 24. It shows that the housing upper part 24 has an outer side wall 35 which directly adjoins the clamping face 27a located in the corner region.

FIG. 8 shows a perspective view of a cable 22 with a crimped-on sleeve 28.

The connection cable has an outer sheath 35 and an inner sheath 36 which surrounds the inner conductor 30. The outer sheath 35 of the cable 28 is stripped in the front end region, with the result that only the inner conductor 30 with its inner sheath 36 and an outer conductor 29 located on the outer circumference of the inner sheath 36 remain. The metal casing 28 is pushed on this thusly stripped end region of the cable 22 and crimped radially inward toward the inner conductor 30 by pressing. This leads to an electrically conductive crimped connection between the inner face of the sleeve 28 and the outer conductor 29.

This crimped connection can also additionally be soldered to the outer conductor 29.

The sleeve 28 may have a diameter which corresponds to the outside diameter of the outer sheath 35 or preferably is somewhat smaller than the outside diameter of the outer sheath 35. This makes it possible to preconfigure the connection cable 28-22 already with a crimped-on sleeve 28, before the cable is inserted from the outside of the device lower part 23 into the cable-entry duct 26.

FIG. 9 shows a detail view of the inner side of a housing lower part 23 from FIG. 6 with a connection cable 22 installed.

It shows that the connection cable 22, after leaving the emerging portion, is bent by 90° and form-fittingly held between the side walls 33, 34 and on the clamping face 27b. As a result, the connection cable 22 is fastened to the housing lower part 23 in strain-resistant fashion.

1. A camera, comprising:
a camera housing;
a lens configured to be screwed to the camera housing, wherein the lens comprises
a cylindrical lens housing,
a lens mount for screwing to the camera housing, and
a front lens element positioned or positionable in the cylindrical lens housing, characterized in that
wherein the lens mount has an encircling flange face next to the camera housing and an annular seal located on the lens mount between the camera housing and the encircling flange face,
wherein the annular seal is elastically deformable in a settable focus region of the camera and is configured to be compressed in the focus region when the lens is screwed to the camera, and
wherein the front lens has a plane surface facing toward the lens mount and is leaktightly connected to the lens housing.

2. The camera according to claim 1, wherein the annular seal has a rectangular, round or oval cross section.

3. The camera according to claim wherein the annular seal is a rubber seal or silicone seal.

4. The camera according to claim 1 wherein an encircling peripheral region of the front lens element is adhesively bonded watertightly to the lens housing.

5. The camera according to claim 1 wherein the lens mount of the lens housing comprises has
a cylindrical screw connection which has an external thread and
a flange adjoining the screw connection,
wherein the external thread has a first diameter and the flange has a second diameter, wherein the second diameter is larger than the first diameter.

6. The camera according to claim 1 wherein the lens mount of the lens housing has a flange with a bayonet connection for screwing the lens to the camera via a bayonet closure, and wherein the annular seal is either located radially on an inside of the bayonet connection or radially on an outside of the bayonet connection on the lens mount.

7. The camera according to claim 1 wherein the lens housing has an annularly encircling plane support face configured for supporting a plane peripheral region of the front lens.

8. The camera according to claim 1 wherein the lens housing has a circumferential side wall enclosing an outer circumference of the front lens.

9. The camera according to claim 1 wherein the encircling flange face is formed on an adapter ring located on the lens housing.

10. The camera according to claim 8, wherein the adapter ring is watertightly connected or connectable to the lens housing on a circumferentially encircling connection region.

11. The camera according to claim 1 wherein the annular seal is force-lockingly and/or form-fittingly connected or connectable to the lens housing.

12. The camera according to claim 1 wherein the camera housing comprises
a housing lower part, and
a housing upper part, and
an electronics printed circuit board positioned or positionable in the housing lower part,
wherein the housing upper part is configured to to be placed onto the housing lower part and connected to the housing lower part,
wherein the housing lower part has a cable-entry duct which leads toward the electronics printed circuit board and has a connection cable, wherein the connection cable is inserted or insertable in the cable-entry duct and electrically conductively connected to the electronics printed circuit board,
wherein a sleeve is crimped onto a the circumference of a stripped end region of the connection cable,
wherein when the housing upper part and the housing lower part are in a connected state, an emerging portion of the cable-entry duct emerges toward an inner wall of the housing upper part that faces toward the housing lower part, and
wherein a clamping intermediate space adjoins the emerging portion and has the sleeve clamped in it by mutually facing clamping faces of the housing upper part and the housing lower part.

12. The camera according to claim 12, wherein the cable-entry duct extends from an outer side of the housing lower part to an inner wall of the housing upper part that faces toward the housing lower part, wherein the emerging portion forms an entire length of the cable-entry duct.

13. The camera according to claim Claim 12 wherein a clamping face of the mutually facing clamping faces is located on of the housing lower part and spans a plane aligned transversely to a direction of longitudinal extent of the emerging portion.
